(19) United States
(12) Patent Application Publication
(10) Pub. No.: US 2009/0048858 A1
(43) Pub. Date: Feb. 19, 2009

(54) Integration Settlement Analyzing Methods of Value Added Service

(75) Inventors: JING ZHANG, Nanjing (CN); FEI XU, Nanjing (CN); KEHUA TAN, Nanjing (CN); ZHIJUN YANG, Nanjing (CN)

Correspondence Address: GLOBAL IP SERVICES, 7285 W. Eagle Court, Winton, CA, 95388, US

(73) Assignee: NANJING LIANCHUANG SCIENCE & TECHNOLOGY INC., LTD., Nanjing (CN)

(21) Appl. No.: 12/054,776

(22) Filed: Mar. 25, 2008

(30) Foreign Application Priority Data
Aug. 16, 2007 (CN) 200710130826.X

(51) Int. Cl. G06Q 10/00

(52) U.S. Cl. 705/1

(57) ABSTRACT

Value added service integrated settlement methods: (1) Firstly setup the transaction model of the integration settlement, that is put the settlement participants as the attribute main body of interface layer: provide data interaction between the inside and the outside of the system; service logical layer: complete the data collection, pretreatment, rule generation application, settlement process operation and settlement result management during the settlement process; data layer: data store based on database technology. (2) The settlement functions of the whole value added services are divided into different settlement processes, according to different models of service operation, different service process various types (short message, downloading, and movies), and different billing elements and settlement references. The same participants will take part in several services. The settlement elements will be put into different settlement processes. The settlement results of different settlement processes will be collected together according to settlement participants to generate the final settlement results. (3) Except the basic service of core settlement operation is adoption loosing coupling settlement operation, all the services relevant calculation processes of settlement are put into independent settlement process.

### CROSS REFERENCE TO RELATED PATENT APPLICATION

This application claims the priority of the Chinese patent application No. 200710130826.X with a filing date of Aug. 16, 2007, which is incorporated herein by reference.

### FIELD OF THE INVENTION

This invention is involved with the analyzing methods of telecoms value added services, especially the analyzing methods of integration settlement on telecoms value-added services.

### BACKGROUND OF THE INVENTION

Presently, the value added services developed by telecom carriers mainly contains wideband value added services, short message value added service, IVR, coloring ring back tone, mobile multimedia email service, streaming media, etc. Compared with traditional telecoms services (like voice service), the operation of above value added services have several remarkable features as below:

The process of service operation is relevant with the cooperation partners, SP/CP. SP/CP provide the content of value added service, including music, videos, games, and so on. The carriers provide customer resources, network communication ability, marketing channel, and billing ability. The carriers with charge the customers and make settlement with SEP/CP, after customers use and pay for the services of SP/CP.

1) According to the variety of value added services, its settlement process is more complex compared with the settlement of traditional voice services. For instance, value added services have some specific charging parameters, like price, flux, duration, order times, contents (URL), bandwidth, service quality, etc. So there are also specific requirements on the collection and transaction of settlement original data.

2) It is more complex to define the settlement policies. The settlement for traditional telecoms voice services is usually among provincial companies and different carriers. While the settlement of value added services come down to different settlement parties, not only the calling and the called, but also multi parties. This is because the process of voice calling only contains two parties, while the value added service generally is related to several SP and carriers.

3) Value added services have a number of categories. It is also an outstanding difficult point to contemporarily support different types of value added services. Considering the current settlement systems, most supporting system providers are adopting the settlement platform similar to voice settlement, including the design methods, functionalities and policy management. Such kinds of system lack the unified supporting to the multi-party settlement, multi-element settlement, diversity of settlement methods, and settlement process among different value added services.

### SUMMARY OF THE INVENTION

The objective of this invention is to plan the settlement analyzing methods and relevant functions aiming at above problems, especially make more reasonable design to several key points, like the data resource collection, settlement methods, and settlement rule policy. Value Added Service Integration Settlement System is responsible to implement the definition of settlement rules, collection of settlement original data, pretreatment, and settlement of charging, generation of settlement result. It meanwhile provides the monitoring and auditing functions of the settlement process. Along with the development and integration of the value added services, there come more and more value added service contents. This invention not only satisfies the current requirement of value added service settlement, but also satisfies the development requirement of the value added services in the future.

The technical solution of this invention is integration settlement methods of value added services. (1) Firstly setup the transaction model of the integration settlement, that is put the settlement participants as the attribute main body of interface layer: provide data interaction between the inside and the outside of the system; service logical layer: complete the data collection, pretreatment, rule generation application, settlement process operation and settlement result management during the settlement process; data layer: data store based on database technology.

The settlement functions of the whole value added services are divided into different settlement processes, according to different models of service operation, different service process various types (short message, downloading, and movies), and different billing elements and settlement references. The same participants will take part in several services. The settlement elements will be put into different settlement processes. The settlement results of different settlement processes will be collected together according to settlement participants to generate the final settlement results.

Except the basic service of core settlement operation is adoption loosing coupling settlement operation, all the services relevant calculation processes of settlement are put into independent settlement process. Different settlement parties in different service settlement processes are reduced as participants. They are using universal entity model, and allow dynamic increase of the attribute. The basic attribute of SP, provincial branches, external system, are all concluded as participants. The participants are linked with settlement types and settlement rules.

Settlement rules and all settlement processes depend on the settlement objects—products.

The definition of settlement parameters also depend on the settlement object—products.

The settlement raw data is defined according to the different service events of the products, including ordering events, sales events, and service events.

According to different settlement processes to define different settlement type and sign different settlement and division agreement.

The settlement rules include: from the perspective of settlement object, settlement according to customers' bill; settlement according to the bill account (like duration, flux and URL); settlement according to SP consuming order; settlement according to SP bill; settlement according to order records; settlement according to service use records; from the perspective of settlement methods, settlement according to the amount of unit price x; settlement of account receivable and received; settlement according to times, price, order times, flux, duration; support various settlement policies: unit price of fixed/flexible settlement; ratio of fixed/flexible settlement; incremental ladder style settlement policy; multi parties settlement.

Different settlement methods are concluded as groupware.

The pretreatment of settlement is an extendable interface.

The analyze methods of the value added service settlement in this invention is shown on the design of the settlement participants, main body, objects; the summary of settlement methods, and the abstraction of the different settlement process.

1. The supporting participants include: network carriers, service providers, content providers, and final customers.

From the perspective of supporting objects, the settlement management provides the following settlement functions:

1) System provide support of settlement rule management and settlement transaction of single SP services (separated by Service ID)

2) System provide support of settlement to products combination and different services of different SP in products

2. From the perspective of settlement objects, the analyse support:

1) Settlement according to customer bill

2) settlement according to the bill account (like duration, flux and URL);

3) settlement according to SP consuming order;

4) settlement according to SP bill;

5) settlement according to order records;

6) settlement according to service use records

3. From the perspective of settlement methods, the analyse support:

1) settlement according to the amount of unit price x;

2) unit price of fixed/flexible settlement; ratio of fixed/flexible settlement; incremental ladder style settlement policy;

Settlement supports both account receivable and account received
The effect of the invention: the main effects of this new settlement analyse methods:
Support the settlement requirements of multiple value added service. Different value added services may have different settlement raw data format and contents according to different service flow. After conclusion and analyses, it can be unified to consuming order by times, ordering order, and service usage order.
unit price of fixed/flexible settlement; ratio of fixed/flexible settlement; incremental ladder style settlement policy;
multi parties settlement
support rapid deployment of new services. When designing the new value added service settlement system, it has been considered about the expandability. The system can rapidly support and deploy the new settlement process

### BRIEF DESCRIPTION OF THE DRAWINGS

FIG. 1 is the system objects relation graph. It is the major logical model for the design of the new value added service settlement system (the universal physical model). It associates the definition of settlement policies to the service events to shield the detailed service process. It associates the definition of settlement rules with product attributes to emphasize the product oriented designing idea. It abstracts the each parties of settlement into participants to support multi party settlement.

FIG. 2 is the system structure graph. It describes the implementation system of how a settlement system is supported. This system structure ensures segregating different settlement services in different settlement physical spaces, and independent the public and basic atom level operations of settlement. All the background service programs are running the load-balanced settlement servers. This increases the usability and expansibility of the system to the greatest extent. In this way, the service development of single settlement will not influence the running of the whole settlement system.

FIG. 3 is the logical implementation graph of this invention

FIG. 4 is the flow chart of the invention (from data source to the applications)

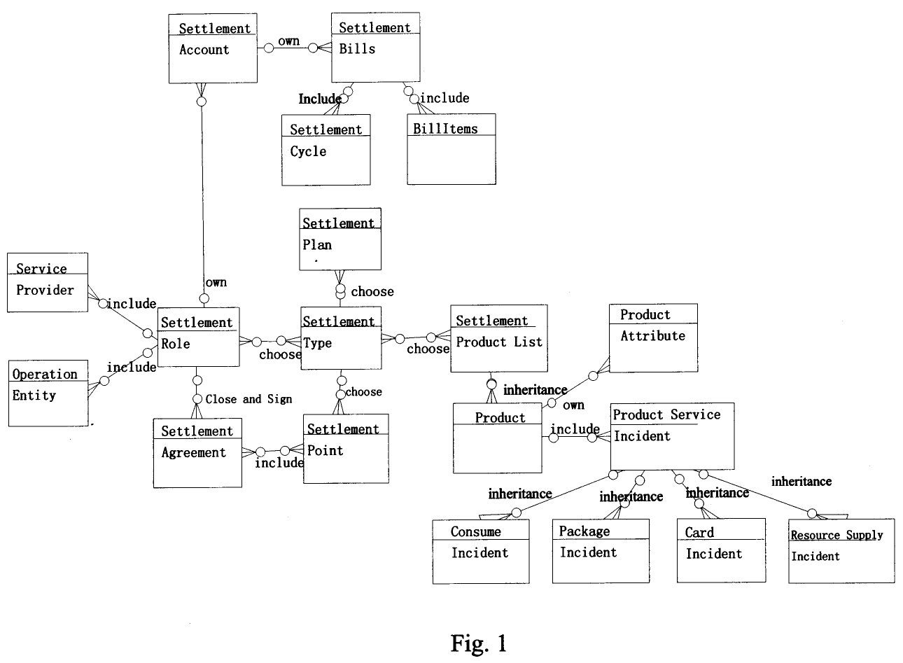

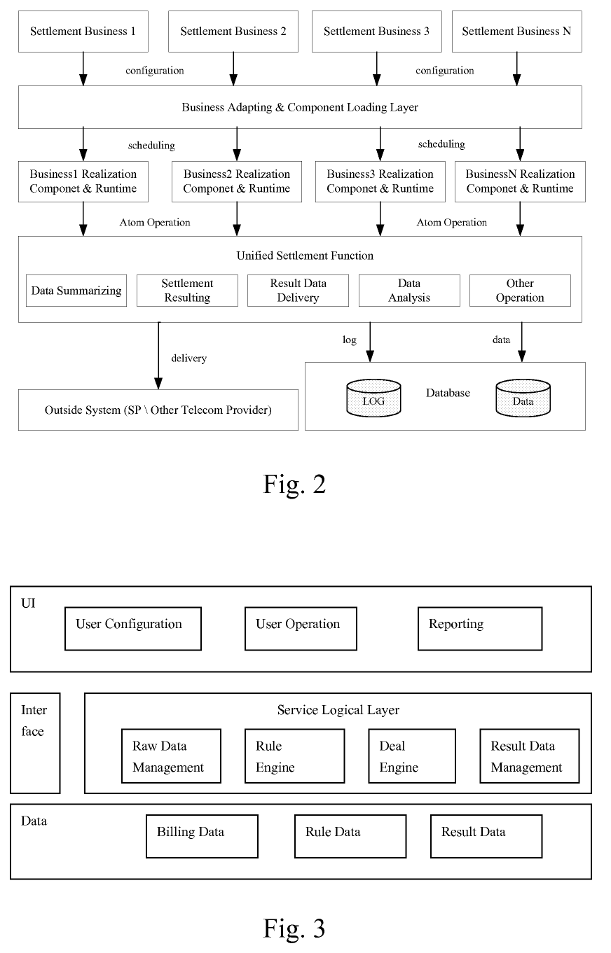

### DETAILED DESCRIPTION OF THE INVENTION

1. Logical Implementation, Please Refer to FIG. 3

Display layer: mainly process the configuration, operation and report forms display based on the management portal and report forms analyse system Interface layer: provide data interaction between inside and outside of the system

Service logical layer: complete the data collection, pre-processing, application of rules generation, operation of settlement process, and settlement result management

Data layer: data storage based on the database technology

2. Technical Implementation Thinking

Aiming at the characteristics of the value added services, there will be multi models of services. Now it may contain short message, download, movies, etc. Different service process has different billing element in CDR, and is relevant with different reference elements of settlement data. So, the settlement functions of whole value added service should be divided into different processes. The same participants will take part in several services. The settlement elements will be put into different settlement processes. The settlement results of different settlement processes will be collected together according to settlement participants to generate the final settlement results.

Except the basic service of core settlement operation, all service relevant settlement calculation will be put into an independent physical implementation space. This loose coupling design will effectively provide rapid support to settlement service, and lower down the cost of further development of new settlement tasks. From the technical structure point of the settlement system, the system contains following characteristics:

a) Conclude different parties of settlement into participants. They are using universal entity model, and allow dynamic increase of the attribute. The basic attribute of SP, provincial branches, external system, are all concluded as participants. The participants are linked with settlement types and settlement rules.

b) According to different settlement process, system can define different settlement type and sign different settlement repartition agreements

c) All the settlement processes depend on the settlement object, products

d) All the definition of settlement parameters also depend on the settlement objects, products. And the system can define settlement origin data, including order event, sales event, service using events, based on the different service events of the products,

As an integrated settlement system, it is necessary to consider the new value added services and the increase of the settlement cost. So the following rules will be followed when defining the settlement rule engine:

a) Different settlement methods are implemented as groupware. Groupware can be linked or disconnected without influencing other settlement methods.

b) Settlement pretreatment is a extendable interface, which can link new pretreatment modules

c) Advanced settlement rule models, which can neatly add various new service types and settlement rules.

d) Unified settlement result display: the settlement result of different types of data and different services can be displayed in one form through good form design, and it can be traced to each detailed point

e) Contemporarily implement the static and dynamic settlement report form display, to get balance between the quantity of the data and the speed of the report form processing.

Define good settlement operation interface to conveniently add new settlement operations in both service management portal and background process.

From the perspective of object supporting, the settlement management provides following settlement functions to service objects:

System supports settlement rule management and settlement process for single SP service (distinguished by Service ID)

System support division and settlement of product combination, which can divide bill according to different SP and different service in the product

Different value added services are divided into several independent settlement process, which is based on following points
Different service has different bill format. For instance, some value added services are billing according to flux, while some are billing according to url
Different service has different data collection lifecycle and different settlement lifecycle. Some services need daily collection of the original data, while some need monthly.
Different service has different pretreatment process. Some services can be integrated to SP level after pretreatment, some needs to be integrated to service level, and some still need to be kept the granularity as the detailed bill level

According to the difference of value added services, the settlement processes are developed independently. Each separately completes the settlement data collection, pretreatment, settlement operation, data generation. The policy configuration, rule definition, and module are completed through one design.
Integrated the characteristics of current value added services, SP usually contemporarily take part in different value added services, and thus participates in multiple settlement process. For instance, some SP participates in not only the settlement of short message service but also the settlement of IVR services and also the settlement of internet value added services. After the settlement of above three settlement processes, it generate the settlement result of this SP and carriers. From the perspective of operation, it needs the conclusion according SP, and the carriers need to do settlement with each SP. This requires the system to conclude after different participants and generate final settlement order. The main processes are:
Format independent settlement result of the settlement process (format required by carriers)
Integrate the settlement data according to the granularity of SP, services, settlement results
Generate final single settlement data

About the programming design, we have adopted the SOA design thoughts. The main settlement process mainly consists of following services: row data collection, pretreatment, rule adapters, settlement implementation, data verification, and result generation.

a) Groupware can be linked or disconnected without influencing other settlement methods.

b) Settlement pretreatment is a extendable interface, which can link new pretreatment modules

c) Advanced settlement rule models, which can neatly add various new service types and settlement rules.

d) Unified settlement result display: the settlement result of different types of data and different services can be displayed in one form through good form design, and it can be traced to each detailed point

e) Contemporarily implement the static and dynamic settlement report form display, to get balance between the quantity of the data and the speed of the report form processing.

f) Define good settlement interface to conveniently add new settlement operation at both the management portal and background process. The new settlement requirement led by new services should be deployed following rules below:
Develop independent services of collection, pretreatment, rules adapter, settlement implementation, data verification, result generation
Distribute new settlement process ID. If there is no settlement methods during the definition, it will following the intrinsic rule model, table structure design, and implement groupware program by configure parameters; if there is any new settlement methods, it is necessary to develop and deploy new rule groupware program
In order to ensure the unit and independency of the service, every service is defined with independent settlement process

From the perspective of supporting objects, the settlement management provides the following settlement functions:

System provide support of settlement rule management and settlement transaction of single SP services (separated by Service ID)

System provide support of settlement to products combination and different services of different SP in products

Contemporarily implement the static and dynamic settlement report form display, to get balance between the quantity of the data and the speed of the report form processing. It is using following stages:

The generation and display of settlement report forms. Adopting dynamic analyse report forms and fixed format report forms to display multi-dimension, data-level, and page-level settlement analyse and report forms for CP, SP, and different departments of carriers. The similar responding time will be supported no matter for data in latest months or great amount of historical data.

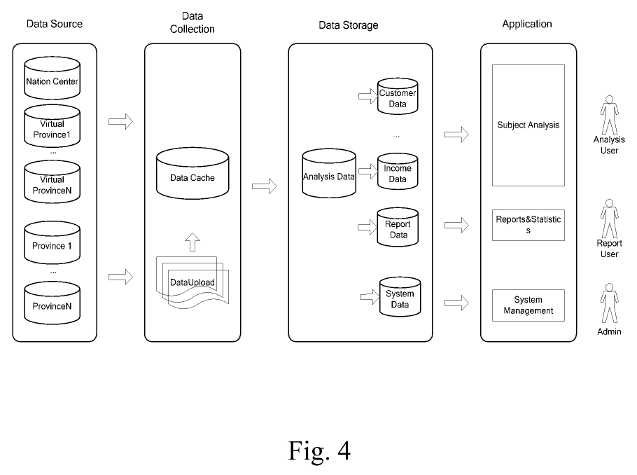

Dynamic report forms emphasize on analyse functions, and are provided for the customers at highest level. It can do enquire of both roll and drill at any dimension on great amount historical data. To achieve this objective, we integrate other data and solve the large amount storage by data warehouse methods, adopt OLAP analyse methods to construct data analyse model, use professional ETL tools to develop whole data collection, cleanup, transfer, and integration system, and load the data into settlement CUBE based on settlement life cycle. In the front end, we adopt drag and play use interface, which can be referred in FIG. 4.

Static report forms is mainly design for some report forms with fixed format and fixed visit objects, such as settlement notification to each participants, settlement result for each settlement participants, and settlement details for each participant operators. This type of report forms pre-designs the report format bound with data structure, and then generate the data according to the parameters sent back by the manages at front ends. It will be sent to the customers after combination to minimize the generation time of the report forms. For some statistic report forms which need large amount data enquiry, we adopting following transaction rules: if it exists in the MOLAP of analyse report, it can be enquired from MOLAP through specific data driver; if it does not exist in the MOLAP of analyse report, it will be generated from the data of middle report during the pretreatment of the data structure.

The OLAP database is the specific database technology, which is subject facing the large amount data enquiry. It is different from the relation database which is based on tables. The solution of OLAP mainly has two types: what we used is the most mature and popular one in the world, MOLAP. Considering the settlement subject: first we define the dimensions (settlement subjects, service providers, content and content providers, roaming types, time and customer location) and indicators (amount before settlement and settlement income); according to these dimensions and indicators, we construct relevant dimension table and fact table, and future complete the data modeling of the CUBE of settlement subject; Then we construct the whole ETL process of Extract, transform, cleanup, integration and generate fact table by lifecycle; then we load the data of fact table into the CUBE of settlement subjects according to lifecycle to generate the OLAP data, which can be enquired by the OLAP display tools on front ends.

What is claimed is:

1. An integrated settlement methods of value added service comprising:
(1) first configure a process model of service integrated settlement, that is to define settlement participants as an attributes main body of an interface layer, provide data interaction between inside and outside of a system, service logical level will complete the data collection, pretreatment, application of rule generation, operation of settlement process, settlement result management, a data layer will store the data based on database technology;
(2) settlement functions of the whole value added services are divided into different settlement processes, according to different models of service operation, different service process various types (short message, downloading, and movies), and different billing elements and settlement references, same participant takes part in several services, settlement elements will be put into different settlement processes, settlement results of different settlement processes will be collected together according to settlement participants to generate final settlement results.
(3) except a basic service of core settlement operation is adoption loosing coupling settlement operation, all services relevant calculation processes of settlement are put into independent settlement process, different settlement parties in different service settlement processes are reduced as participants; they are using universal entity model, and allow dynamic increase of attribute. Basic attributes of SP, provincial branches, external system, are all concluded as participants, the participants are linked with settlement types and settlement rules.

2. The integration methods of value added service of claim 1, wherein groupwares of different settlement methods can be linked or disconnected and a pretreatment of settlement is an expansible interface.

3. The integration methods of value added service of claim 1, wherein adopting SOA design methods, the core settlement process thereof includes: raw data collection, pretreatment, rule adaption, settlement application, data verification, and result generation.

4. The integration methods of value added service of claim 1, wherein dynamic display methods of settlement reports with following stages:
dynamic report forms integrate other data and solve large amount storage by data warehouse methods, adopt OLAP analyse methods to construct data analyse model, use professional ETL tools to develop whole data collection, cleanup, transfer, and integration system, and load data into settlement CUBE based on settlement life cycle, in the front end, adopt drag and play use interface.

5. The service integration methods of value added service of claim 4, wherein the balance between report amount and report speed having following stages: static report forms are mainly designed for some report forms with fixed format and fixed visit objects, such as settlement notification to each of participants, settlement result for each of settlement participants, and settlement details for each of participant operators, this type of report forms pre-designs a report format bound with data structure, and then generate the data according to the parameters sent back by manages at front ends, it will be sent to customers after combination to minimize generation time of the report forms, for some statistic report forms which need large amount data enquiry, adopting following transaction rules: if it exists in the MOLAP of analyse report, it can be enquired from MOLAP through specific data driver; if it does not exist in the MOLAP of analyse report, it will be generated from the data of middle report during the pretreatment of the data structure.
